(19) United States
(12) Patent Application Publication
(10) Pub. No.: US 2011/0128385 A1
(43) Pub. Date: Jun. 2, 2011

(54) MULTI CAMERA REGISTRATION FOR HIGH RESOLUTION TARGET CAPTURE

(75) Inventors: Saad J. Bedros, West St. Paul, MN (US); Ben Miller, Minneapolis, MN (US); Michael Janssen, Minneapolis, MN (US)

(73) Assignee: Honeywell International Inc., Morristown, NJ (US)

(21) Appl. No.: 12/629,733

(22) Filed: Dec. 2, 2009

(51) Int. Cl. H04N 5/33; H04N 5/225; H04N 5/262; H04N 5/228

(52) U.S. Cl. 348/164; 348/262; 348/240.99; 348/222.1; 348/E05.024; 348/E05.055; 348/E05.09; 348/E05.031

(57) ABSTRACT

A multi-camera arrangement for capturing a high resolution image of a target. A first camera may be for capturing a wide field of view low resolution image having a target. The target or a component of it may be border-boxed with a marking. The target may be a human being component, such as a face, having approximately the same size among virtually all humans. A distance of the target may be determined from a known size of a component of the target. The target may be other items of similar size. Coordinates of pixels of the image portion containing the target may be mapped to a pan, tilt and zoom (PTZ) camera. The pan and tilt of the PTZ camera may be adjusted according to image information from the wide field of view camera. Then the PTZ camera may zoom in on the target to obtain a high resolution image of the target.

The U.S. Government may have certain rights in the subject invention.

### BACKGROUND

The invention pertains to imaging and particularly to imaging of targeted subject matter. More particularly, the invention pertains to achieving quality images of the subject matter.

### SUMMARY

The invention is a system for improved master-slave camera registration for face capture with the slave camera at a higher resolution than that of the master camera. Estimation of face location in the scene is made quick and more accurate on the basis that sizes of faces or certain other parts of the body are nearly the same for virtually all people. With no 3D camera calibration, the information from the 2D image of the master camera leads to multiple physical locations in the scene. For face or upper body targeting, an assumptions of the average height of a person leads to specific positioning of the slave camera. However, the height of the person can vary for tall and short people resulting in larger positioning errors. Distance estimation based on the face or upper body size may make it possible for a slave camera to quickly position and obtain a high quality image of a target human sufficient for identification or for relevant information leading to identification or recognition of the target. This approach may used in the case of automobiles and license plates. This approach may apply to other items having consistent size characteristics.

### BRIEF DESCRIPTION OF THE DRAWING

FIG. 1 is a diagram of a master and slave camera system;

FIG. 2a is a diagram of an overview of a master-slave pan, tilt and zoom calibration and control graphical user interface;

FIG. 2b is a diagram of a pan, tilt and zoom camera control panel;

FIG. 2c is a diagram of a draw controls array;

FIG. 2d is a diagram of an image display controls array;

FIG. 3 is a diagram of camera having a wide field of view which encompasses targets at difference distances;

FIG. 4 shows a side view of a camera capturing an image of faces of persons of different heights but having faces of the same size;

FIG. 5 is a camera image of three people having different heights and/or sizes at the same distance from the camera and having faces of the same size;

FIG. 6 is a diagram illustrating computation of an optical centre using an intersection of four optical flow vectors estimated in an sense;

FIG. 7 is a diagram of a calibration target divided into several rectangular blocks with the strongest corner point being picked up from each of the blocks;

FIGS. 8a and 8b show plots of zoom values vis-à-vis height and width ratios, respectively;

FIGS. 8c and 8d are plots of a relationship between the log ratios of height and width and zoom values, respectively;

FIG. 9 is a table of position errors computed for examples using target width or height based on which a zoom factor is applied; and

FIG. 10 is a table of scaling errors computed for examples using target width or height based on which a zoom factor is applied.

### DESCRIPTION

The present invention may be a system for master-slave camera registration for a high resolution face capture.

Target registration with master slave camera system appears important for capturing high resolution images of face for recognition. A problem with 2D image registration is that it does not necessarily map a true location of the face from a 2D master camera to the pan tilt and zoom control of a slave camera due to a limitation of 2D mapping in a 3D world.

By estimating the distance of the face with the size of the face, the size of the face is used in the image registration mapping process for a more accurate targeting of the face for high resolution capture. Tall people and short people should have nearly the same size of face. They may be located in different locations in the master image, and be mapped to different locations in the world. By integrating face size to the mapping process, faster and more accurate capture may be achieved.

For face recognition system at a distance with master slave cameras, the registration is done very fast with people at different heights presented to the system.

Two cameras, master and slave, may be utilized. They are not necessarily uncalibrated cameras. There may be automatic registration and mapping of the master camera pixels and a pan, tilt and zoom parameters of the slave camera.

Information from an acquired image of a face in the master camera may be used to do better mapping. Face size may be regarded as nearly constant, from one person to another. Different heights of people may indicate different distances but this could be misleading relative to accurate mapping because the people may actually have different heights and thus not necessarily be at different distances from the camera. The constant face size assumption for people of different heights appears to be true. This factor may lead to good mapping and better targeting to the face in a quick manner.

Given a face of a given size captured by an automatic or manual detector, registration of the master and slave cameras may be done using a face detector of both cameras. The center of the face may be designated by coordinates “x,y”.

Pan, tilt and zoom parameters for the slave camera may be computed. This mapping function may be expressed in a second or third order polynomial. This mapping function may be extended to use information of the face to extend the mapping.

The master camera may provide a low resolution wide field-of-view image incorporating a target such as a face. The slave camera may provide a high resolution image of the target with pan and tilt to center in on the target and with a zoom to get a close-up image of the target. The low resolution view of the target may be as small as 20×20 pixels in the wide-field view of the master camera which may be a limiting factor for a good image of the target with the master camera. Thus, a slave camera may come in to get a better view for detection and recognition of the target. Mapping and registration of the image in both cameras may be obtained. Then one may move in or get close with the slave to get a high resolution image of the target, especially where the target or targets are moving. Knowing the target size aids greatly in distance and location of the target. With faces being approximately the same size among virtually all people, whether tall or short, and the target being a face may result in knowing the target size and its distance from the system.

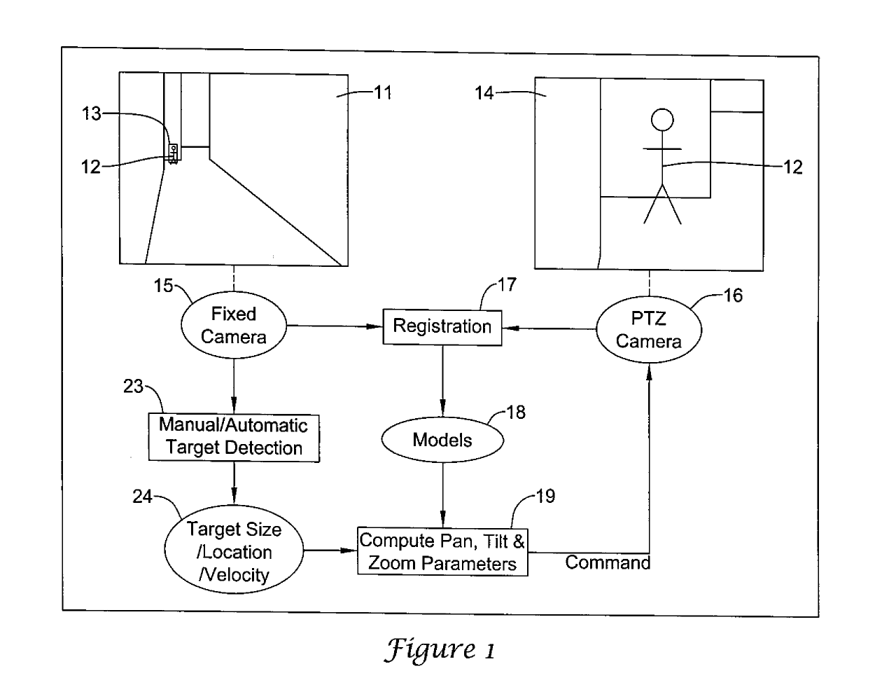

FIG. 1 is a diagram of a wide field of view image 11 from a master camera 15 with a target 12 delineated with a border, bounding box, or other appropriate marking 13. Mapping x, y coordinates from the master camera 15 to a slave camera 16 permits the slave camera to accurately and quickly zoom in at the location of the target 12 in low resolution image 11 to obtain a high resolution image 14 of the target 12. Camera 15 may be regarded as a fixed camera with a wide field of view. Camera 14 may be regarded as a pan, tilt and zoom camera.

Cameras 15 and 16 may have outputs to a registration module 17. An output from module 17 may provide models 18 to a module 19 for computing pan, tilt and zoom parameters. Camera 15 may also provide an output to a manual or automatic target detection module 23. An output 24 of target size, location from module 23 may go to module 19 for computation of the pan, tilt and zoom parameters which may be sent as command signals to PTZ camera 16 for control of the camera in accordance with the parameters.

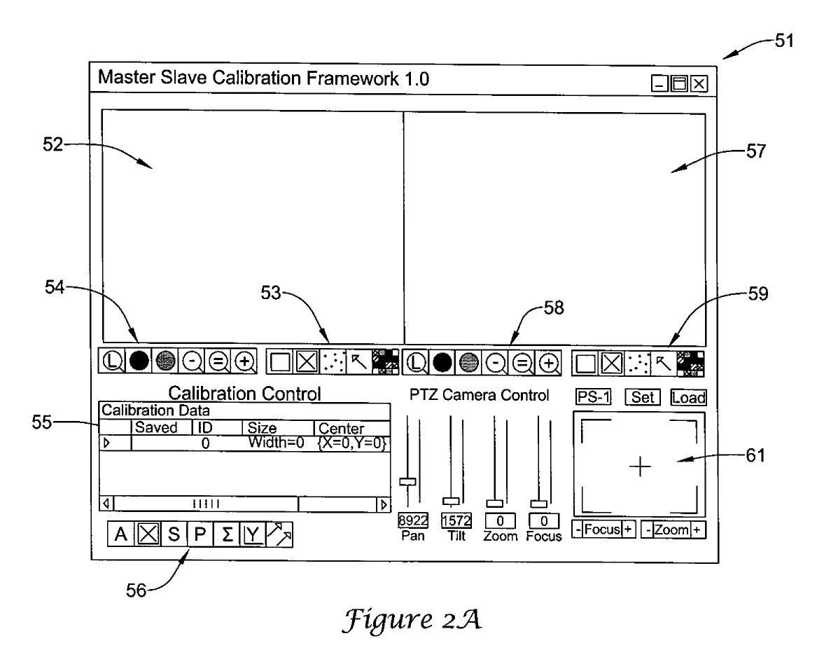

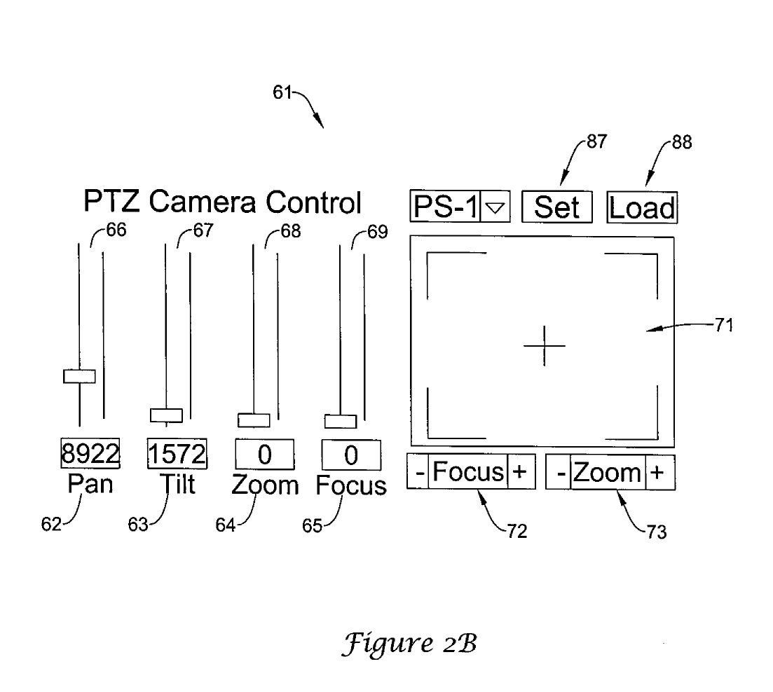

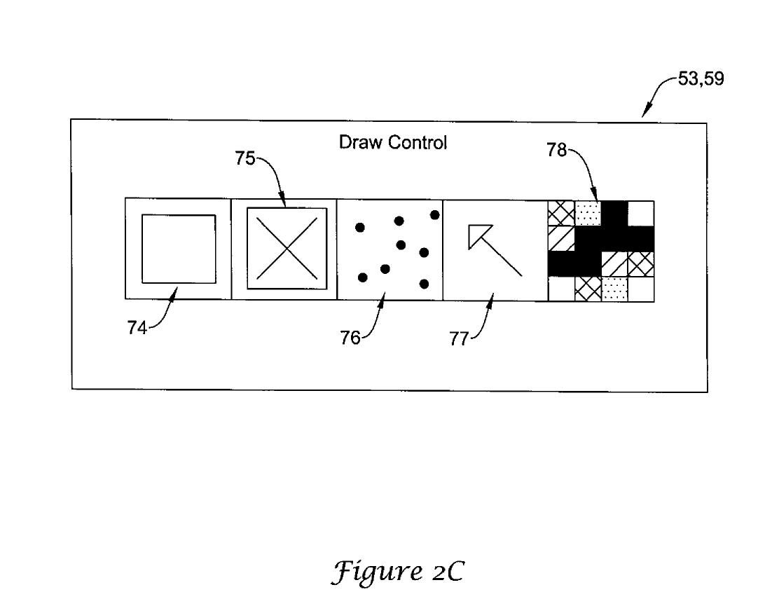

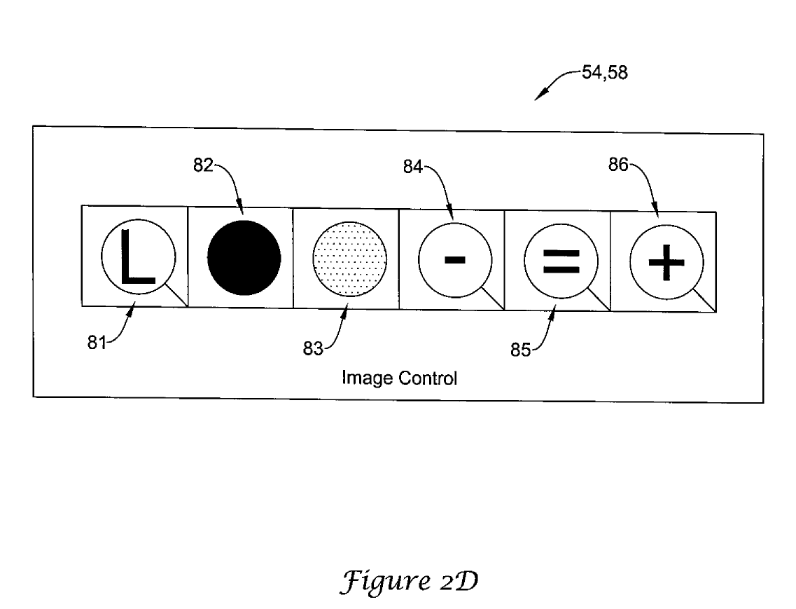

FIG. 2a is a diagram of an overview of a master-slave PTZ calibration and control graphical user interface 51. For the master camera portion, there is a fixed image view 52, a fixed image draw controls 53 and fixed image display controls 54. There is a calibration control unit 55 with calibration controls 56. For the slave camera portion, there is a PTZ image view 57, PTZ image display controls 58, PTZ image draw controls 59 and a PTZ control panel 61.

FIG. 2b is a diagram of a PTZ camera control panel 61. The panel may have pan, tilt, zoom and focus control text boxes 62, 63, 64 and 65, respectively. Associated with text boxes 62, 63, 64 and 65 may be control track bars 66, 67, 68 and 69, respectively. Area 71 may be for relative and fine pan-tilt control. There may be a fine focus control 72 and a fine zoom control 73. Also, there may be a save preset button 87 and a load preset button 88.

FIG. 2c is a diagram of a draw control array which is representative of both the fixed image and PTZ image draw controls 53 and 59, respectively. Individual controls may encompass a draw box control 74, a delete drawing control 75, a draw point control 76, a pointer select control 77 and a choose draw color control 78. There may be other configurations with more or less image draw controls.

FIG. 2d is a diagram of an image display control array which is representative of both the fixed image and PTZ image draw controls 54 and 58. Individual controls may encompass a load camera control 81, a freeze video control 82, an unfreeze video control 83, a zoom out control 84, a zoom default control 85 and a zoom in control 86. There may be other configurations with more or less image display controls.

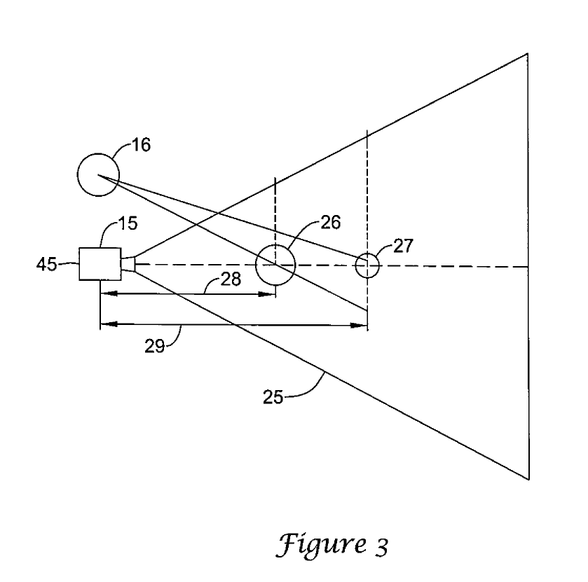

FIG. 3 is a diagram of camera 15 having a wide field of view 25 which encompasses targets 26 and 27. The size of the targets 26 and 27, or like components of them, may be regarded to be the same. Illustrative examples may include faces or torsos of humans and license plates of vehicles. These items or targets 26 and 27 may decrease in size on an imaging sensor 45 of camera 15 relative to increased distances 28 and 29, respectively, as represented by their sizes in the diagram of FIG. 3. The farther the target or item from camera 15, the smaller may its image be on sensor 45. This information of the sizes of the targets and of their images on sensor 45 of camera 15 makes it possible to calculate distances and/or positions of the targets. Based on the information, command signals for pan, tilt and zoom may be provided to camera 16 for capturing an image of the target 26 or 27 having a resolution significantly higher than the resolution of the target in a wide field of view image captured by camera 15.

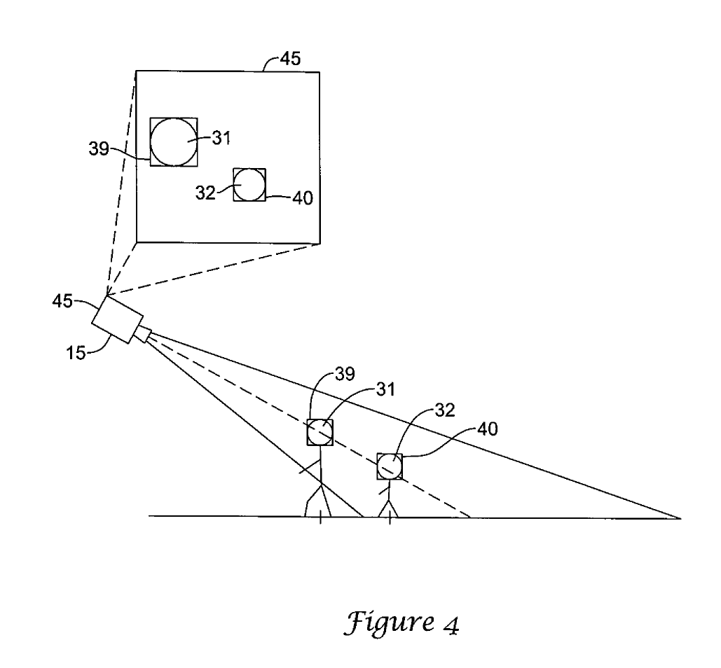

FIG. 4 shows a side view of camera 15 and targets 31 and 32, capturing an image of faces of persons 31 and 32, which are delineated by squares 39 and 40, respectively. The persons may have different heights and/or sizes but have faces of the same size and thus the same-sized squares framing their faces, as illustrated in the diagram. The image sizes of the squares 39 and 40 on sensor 45 of camera 15 may indicate the distances of faces and corresponding persons 31 and 32 from camera 15. The size of square 40 appearing smaller than the size of square 39 may indicate that person 32 is at a greater distance from sensor 45 than person 31.

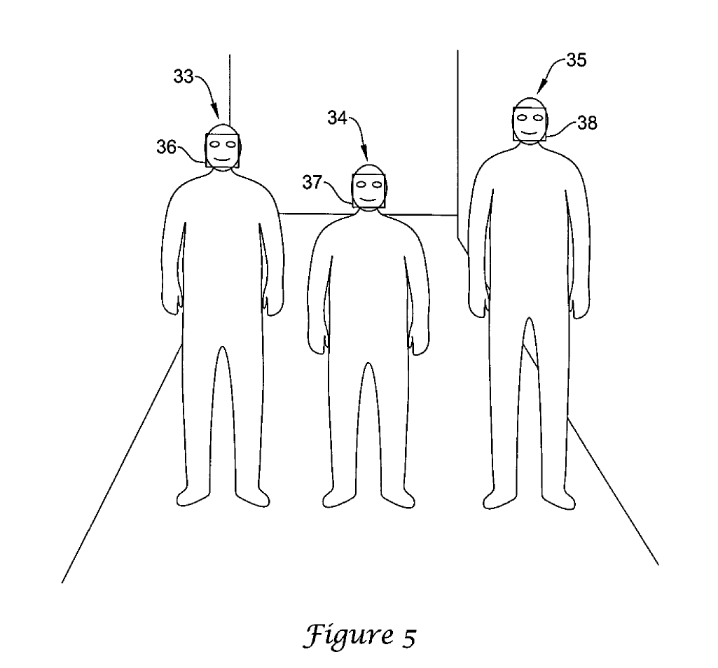

FIG. 5 is a camera image of three people 33, 34 and 35 of different heights and/or sizes at the same distance from the camera. The image of persons 33, 34 and 36 reveals faces having virtually the same size as indicated by the bordering boxes 36, 37 and 38, respectively, having the same size.

The master and slave cameras may be co-located within a certain distance of each other. The closer the cameras are to each other, smaller may be an error. The two cameras may be along side or on top of each other. Also a better target, such as one of a known size, may result in better registration between the two cameras. Besides faces of people, torsos of people (i.e., the upper portions of people) may be somewhat the same in size as good targets for faster registration and more accurate calibration. If one or two of the cameras are moved, then the registration may need to be redone. This need appears applicable to cameras positioned laterally or vertically relative to each other (i.e., on top of each other).

A primary application of the present system involves face technology. Registration that incorporates adjustments for people of differing heights may be time consuming and not necessarily accurate. If the distance from the cameras to the person is known, then registration and mapping may be generally quite acceptable. With the present system, the distance from the camera to a person may be estimated by the size of the person's face. In essence, mapping may be based on face size. So people of different heights may be regarded as having the same face or torso size. Generally, face size does not necessarily vary significantly among people. Correlations of face or torso size with heights of people do not exist well.

The approach may used in the case of automobiles and license plates. Automobiles and/or license plates may generally be regarded as having the same size. This approach may apply to other items having consistent size characteristics.

A primary core of the present system is the capability to provide automatic and accurate mapping between the master and slave cameras besides just the mapping between the pixel coordinates of the camera, and pan and tilt parameters. Jittering of one or more of the cameras is not necessarily an issue since a quick update of the registration and mapping of the target may be effected.

Target acquisition of the present system may be for people recognition. The face may be just one aspect. An objective is to obtain a quick capture with high resolution of people on the move. If larger error is tolerable in target acquisition, then less time maybe tolerated for image capture of a target. The speed of the intended target, say at a 100 meters distance, a slight variation of its speed may affect panning and tilting of the slave camera and the loss of the target capture.

The cameras may have image sensors for color (RGB), black and white (gray scale), IR, near IR, and other wavelengths.

A PTZ camera can operate in tandem with a fixed camera to provide a zoom-in view and tracking over an extended area. One scenario may be a PTZ camera operating in tandem with one or more other fixed cameras. Another scenario may be one or more PTZ cameras operating in tandem with one fixed camera. Each PTZ camera may zoom in on a target in that several PTZ cameras could cover several targets, respectively, in the field of view of the fixed camera. The system may be a master-slave configuration with zoom-to-target capability.

The potential target market is wide area surveillance with the ability to gather the relevant details of an object by utilizing the capabilities of a PTZ. Customers are critical infrastructure, airports/seaports, manufacturing facilities, corrections, and gaming.

An application may use fixed camera target parameters along with a relative master-slave calibration model to point the PTZ camera to look at the target. The fixed camera will be mounted in the same vicinity as the PTZ camera.

The master-slave camera control relies on a one-time calibration between the master and slave camera views. The calibration step includes computation of: 1) PTZ camera optical centre; 2) Model for zoom as a function of a PTZ camera zoom reading, and 3) Relative pan and tilt calibration between the fixed master and PTZ cameras.

During the control operation, for a given target in the master image (or PTZ wide field of view) defined in terms of a bounding rectangle located (centered) at (x, y) and having size (Δx, Δy), the calibration models are used to compute PTZ pan, tilt and zoom parameters that will generate a PTZ image having the same rectangular region (world) lying at PTZ image centre occupying P percent of the PTZ image.

Under this mode the PTZ camera operates in a wide field of view mode (typically the PTZ's home position) under normal operation and zooms on to any target detected under the wide field of view mode. After providing the close-up view, the PTZ camera then reverts back to an original view mode to continue monitoring for objects of interest. A high level block diagram of the master-slave camera control implementation is given in FIG. 1.

Similarly, certain PTZ cameras support querying of the camera's current position (pan, tilt and zoom values, also referred to as “camera ego parameters”), while others do not. A master-slave camera control algorithm developed within the framework of this application may work using minimum support from the PTZ camera and should not require reading ego parameters from the camera.

For zooming on to target, it is essential to position the target at optical centre (not image centre) before zooming on to it. Otherwise, the object undergoes an asymmetrical zoom and so will not stay in the center of the image. Placing the object at image centre results in migration of the image as it is zoomed on.

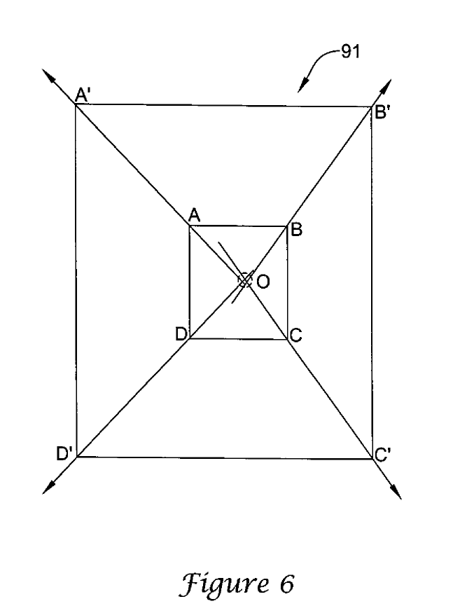

The optical centre may be computed using the intersection of four optical flow vectors estimated in a least squares sense. The approach is illustrated geometrically in a diagram 91 of FIG. 6. ABCD represents the bounding box drawn at zero zoom; while A′B′C′D′ represents the bounding box drawn at a higher zoom. The optical flow vectors AA′, BB′, CC′ and DD′ all converge to the optical centre (O).

If a set of points in image coordinate at a lower zoom level is given by (x₀ⁱ,y₀ⁱ|i=1, 2, 3, 4) and the corresponding points at a higher zoom level is given by (x₁ⁱ,y₁ⁱ|i=1, 2, 3, 4), then the formulation for computation of optical centre (x_{c},y_{c}) is given by,

$$[ \begin{matrix}- ( {y}_{1}^{0} - {y}_{0}^{0} ) & ( {x}_{1}^{0} - {x}_{0}^{0} ) \\ - ( {y}_{1}^{1} - {y}_{0}^{1} ) & ( {x}_{1}^{1} - {x}_{0}^{1} ) \\ - ( {y}_{1}^{2} - {y}_{0}^{2} ) & ( {x}_{1}^{2} - {x}_{0}^{2} ) \\ - ( {y}_{1}^{3} - {y}_{0}^{3} ) & ( {x}_{1}^{3} - {x}_{0}^{3} )\end{matrix} ] \times [ \begin{matrix}{x}_{c} \\ {y}_{c}\end{matrix} ] = [ \begin{matrix}{y}_{1}^{0} ( {x}_{1}^{0} - {x}_{0}^{0} ) - {x}_{1}^{0} ( {y}_{1}^{0} - {y}_{0}^{0} ) \\ {y}_{1}^{1} ( {x}_{1}^{1} - {x}_{0}^{1} ) - {x}_{1}^{1} ( {y}_{1}^{1} - {y}_{0}^{1} ) \\ {y}_{1}^{2} ( {x}_{1}^{2} - {x}_{0}^{2} ) - {x}_{1}^{2} ( {y}_{1}^{2} - {y}_{0}^{2} ) \\ {y}_{1}^{3} ( {x}_{1}^{3} - {x}_{0}^{3} ) - {x}_{1}^{3} ( {y}_{1}^{3} - {y}_{0}^{3} )\end{matrix} ] . \qquad ( 1 )$$

Note that the process of determining the optical centre for the PTZ camera can be included in the manufacturing process for the PTZ camera and so for more; cameras could be made available as a factory defined parameter, saving the user from having to perform this calibration step.

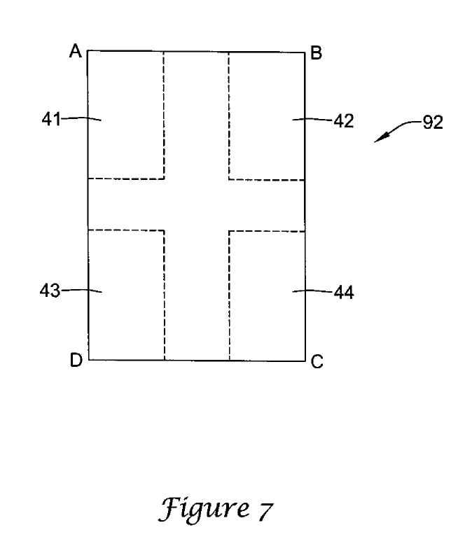

Automatic estimation of a bounding box may be done during zoom calibration. The calibration target is divided into four rectangular blocks 41, 42, 43 and 44, as shown in a diagram 92 of FIG. 7. The strongest feature of a known Harris approach for each of the rectangular blocks may be computed. Under zoom change, the zoomed image may be searched to find the best match of Harris corner features computed at the previous zoom level using block matching (normalized cross correlation). An affine transformation model for the target may be computed for the zoom change. The new bounding box may be computed based on this affine model. The bounding box at the new zoom level may again be divided into four rectangular blocks and computation of the strong Harris feature for each of the blocks is then repeated. The zoom value is increased and the bounding box estimation step may be repeated for the new zoom level.

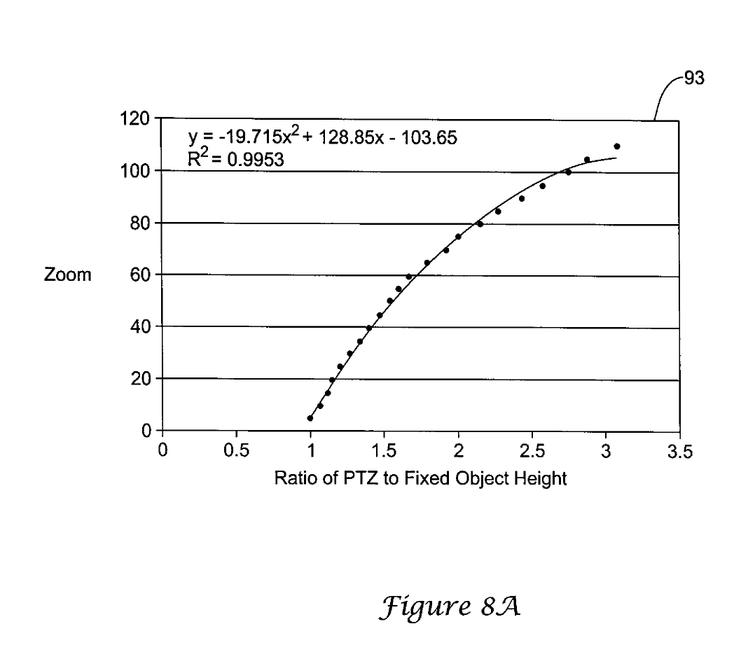

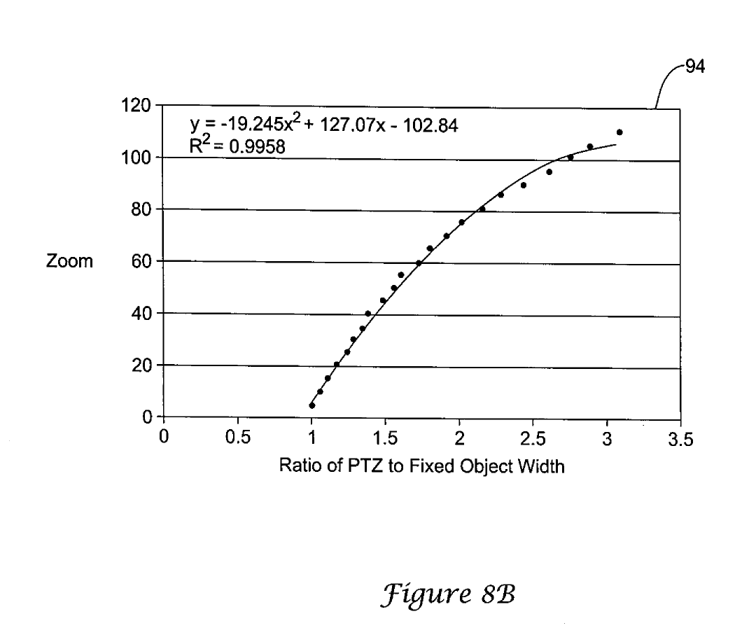

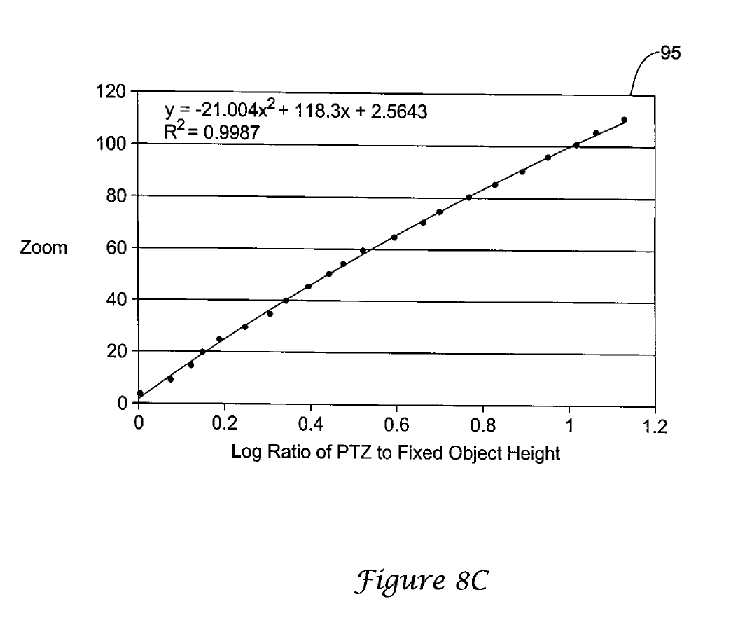

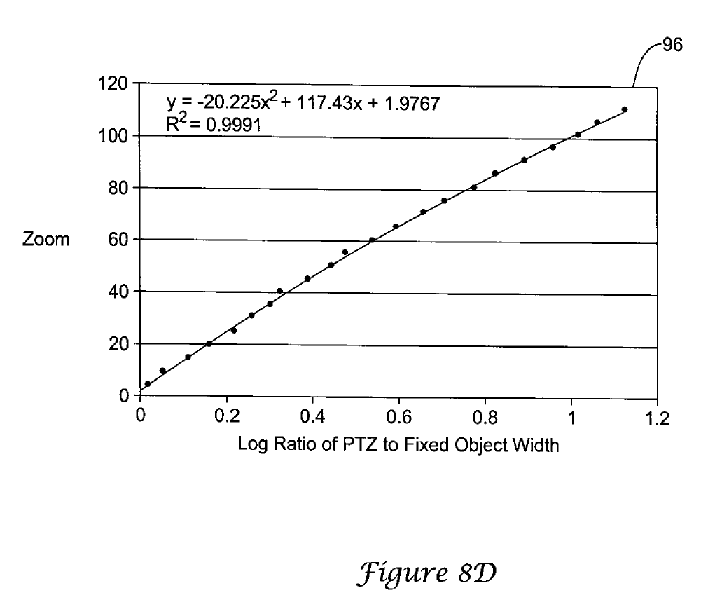

A zoom model may be computed. The basic input for zoom modeling may be the height and width of the calibration target in the fixed image, and the height and width of the same target in the PTZ image at every zoom step. The height and width of the calibration target in the PTZ image at each zoom step may be divided by the corresponding height and width in master/fixed camera to compute height and width ratios. Zoom modeling for a master-slave configuration is shown in FIGS. 8a-8d. FIGS. 8a and 8b show the plot of zoom value vis-à-vis height and width ratios. FIG. 8a is a graph 93 of zoom versus a ratio of PTZ to fixed object height. FIG. 8b is a graph 94 of zoom versus a ratio of PTZ to fixed object width. The relationship may be expressed in terms of a second degree polynomial. A more convenient approach may be to establish a functional relationship between the log ratio (height or width) and the zoom values (in graphs 95 and 96 of FIGS. 8c and 8d, respectively). A linear model fits well for this model. However, the second degree polynomial may be used in a more generic sense.

A pan-tilt modeling may be computed. Pan-tilt modeling may establish a relationship between the fixed camera coordinates and the PTZ camera pan and tilt values that are required to position the target at the PTZ camera's optical centre. The modeling may result in two separate polynomial models for pan and tilt, but may be carried out under a single step. This calibration may be carried out a person standing at a number of locations on the ground plane to achieve reasonable coverage of the scene. The camera zoom value during the pan-tilt calibration should be kept fixed. The calibration approach used in the current solution may establish separate calibration models for zoom and rotation (pan and tilt). Hence, zoom may be treated as an independent variable and be kept fixed during pan and tilt calibration. Using the computed pan-tilt model, it may be possible to maneuver the PTZ camera to look at any object in master view provided that the zoom is kept fixed to a value which was used during pan-tilt calibration. For each position of the calibration target (e.g., a standing person), the PTZ camera may be maneuvered to look at the target, i.e., the target is positioned at the PTZ camera optical centre. However, it may not be possible to manually control the movement of the PTZ camera so as to position it perfectly at an image optical centre. Thus, the PTZ camera may be automatically panned to left and right by, for instance, one degree, and the target displacement may be measured using block matching (e.g., normalized cross correlation). The same may be repeated by applying, for instance, one degree tilts in up and down directions. With a face detector, the PTZ camera may be automatically panned and tilted for best positioning of the camera. The centre of the target may be defined as the centre of the target bounding box. If using pan and tilt values (P and T) respectively positions the calibration target at location (x,y) while the optical centre of PTZ camera is at (x_{c},y_{c}), then the corrected values of pan and tilt (P_{c} and T_{c}) required to position the target at optical centre may be given by,

$$\begin{matrix}{P}_{c} = P + \frac{\partial P}{\partial x} ( x - {x}_{c} ) + \frac{\partial P}{\partial y} ( y - {y}_{c} ) & ( 2 ) \\ {T}_{c} = T + \frac{\partial T}{\partial x} ( x - {x}_{c} ) + \frac{\partial T}{\partial y} ( y - {y}_{c} ) . & ( 3 )\end{matrix}$$

A pan or tilt model may be expressed in terms of a polynomial function of fixed camera image coordinates. The nature of the model may depend upon the relative placement of the two cameras. If the two cameras are widely separated, a quadratic model may be recommended. A bilinear model may be recommended face targeting.

A quadratic pan and tilt models may be given by,

P=p₂₀x²+p₀₂y²+p₁₁xy+p₁₀x+p₀₁y+p₀₀ (4)

T=t₂₀x²+t₀₂y²+t₁₁xy+t₁₀x+t₀₁y+t₀₀. (5)

A bilinear model for pan and tilt may be defined as,

P=p₂₀x+p₀₂y+p₁₁xy+p₀₀, (6)

T=t₂₀x+t₀₂y+t₁₁xy+t₀₀. (7)

A linear model for pan and tilt may be defined as,

P=p₁₀x+p₀₁y+p₀₀, (8)

T=t₁₀x+t₀₁y+t₀₀, (9)

where pᵢⱼ and tᵢⱼ are the coefficients of pan and tilt models, respectively.

The new solution may use the same approach as in equations 4-9; however, one may also add a linear model of face size parameter to these equations. The model may also be nonlinear. The resulting equations may be as in the following.

A quadratic pan and tilt models may be given by,

P=(p₂₀x²+p₀₂y²+p₁₁xy+p₁₀x+p₀₁y+p₀₀)(q1s+q0)), (10)

T=(t₂₀x²+t₀₂y²+t₁₁xy+t₁₀x+t₀₁y+t₀₀)((q1s+q0). (11)

A bilinear model for pan and tilt may be defined as,

P=(p₂₀x+p₀₂y+p₁₁xy+p₀₀)(q1s+q0), (12)

T=(t₂₀x+t₀₂y+t₁₁xy+t₀₀)(q1s+q0). (13)

A linear model for pan and tilt may be defined as,

P=(p₁₀x+p₀₁y+p₀₀)(q1s+q0), (14)

T=(t₁₀x+t₀₁y+t₀₀)(q1s+q0) (15)

In this case, the model may need a minimum of two heights per solution. Additional heights may lead to a quadratic solution.

A quadratic model may be a generic model that works for virtually all circumstances. However, the number of control points required to solve a quadratic model may be more than that for a linear model. The minimum number of control points required for a linear model may be regarded as 3, while the same for the bilinear and quadratic models may be regarded as 4 and 6, respectively. Thus, the pan and tilt calibration may be performed in an incremental fashion. During pan-tilt calibration, a linear model may be internally computed as soon as three control points are acquired. This linear model may be used for automatically maneuvering the PTZ camera during the subsequent control point acquisition to reduce the amount of manual control required to bring the target to the right position. Higher order models (bilinear and quadratic) may be computed whenever the required number of points to compute the higher order model is made available.

A known RANSAC (RANdom SAmple Consensus) method may be used to remove control points that are outliers. A production version should also support manual editing (selective rejection) of control points during calibration. This may be required to filter out any erroneously acquired point during calibration process. Each point acquired during pan-tilt calibration may show its contribution to model error once a model is computed, i.e., after acquiring three control points. The points with high error may be interactively deleted and overall reduction in model error will justify its inclusion or exclusion. Moreover, the target might have been inadvertently moved or occluded during the acquisition of local gradient making the control point a known outlier.

The PTZ camera may be controlled by using a fixed master. In master-slave camera control, the PTZ camera does not necessarily contain any intelligence during the control phase. The target position and size as observed in the master image coordinate may be used to compute the PTZ camera pan, tilt and zoom values. The target distance as indicated by target size may be used to compute the pan and tilt values since the zoom value may be computed based on the ratio of desired target size in the PTZ camera to the observed target size in the fixed camera view. The desired object size may be expressed as a percentage of the maximum size of detection possible using a PTZ camera. For a PTZ camera having image width W, image height H and optical centre (x_{c},y_{c}), the maximum possible detectable target width Wₘₐₓ and height Hₘₐₓ may be given by,

Wₘₐₓ=2*min(x_{c},W−x_{c}), (16)

Hₘₐₓ=2*min(y_{c},H−y_{c}). (17)

The desired width and height may be expressed as P percentage of the maximum possible width and height values. Width and height of the observed target may suggest two different zoom settings based on the desired target width and height values. A minimum of the two zoom values may be used in operation so as to get the desired size for the target. For a fast moving target, it may be desirable to compute the pan, tilt and zoom values based on the predicted target location and size taking into account the PTZ command latency. One way to deal with uncertainty in target velocity may be to operate at a lower zoom so as to account for error in velocity estimation (standard deviation of velocity). The zoom target (desired target size in PTZ image) for high speed object should be lower than that for the static and slow moving objects.

Calibration of a single PTZ camera may be controlled by freezing the PTZ view to a wide field of view while the camera is maneuvered to acquire the view in PTZ mode. Pan and tilt calibration under such scenarios may be invariably much simpler than the laterally separated fixed and PTZ camera configurations.

The PTZ Camera may be controlled by using its wide field of view. The target parameters in a PTZ camera view may be used to compute the PTZ camera ego parameters (i.e., pan, tilt and zoom values) required to capture the target at a desired size. These values may be computed for a predicted target position and size rather than observed target parameters taking into account a latency in PTZ command execution.

During evaluation, a target (such as a person) may be positioned at different locations. The operator may be asked to draw a bounding box surrounding the target or an automatic program may be detects the bounding box surrounding the target and the PTZ camera may be automatically maneuvered to acquire a high zoom image of the target at a desired size using the calibration models. Errors may be measured in terms of location error and scale error. The location error in x and y directions may be given by,

$$\begin{matrix}{e}_{x} = \frac{( {x}_{c} - {x}_{t} )}{W / 2} , & ( 18 ) \\ {e}_{y} = \frac{( {y}_{c} - {y}_{t} )}{H / 2} , & ( 19 )\end{matrix}$$

where the (x_{c},y_{c}) represents the optical centre, and W and H represent the width and height of the image.
The overall location error may be given by

eₚ=\sqrt{(eₓ²+e_{y}²)}. (20)

The scaling error may be given by,

$${e}_{s} = \frac{\vert {d}_{s} - {o}_{s} \vert}{{d}_{s}} . \qquad ( 21 )$$

where dₛ is a desired target size for which the zoom was computed, and oₛ is the observed target size.

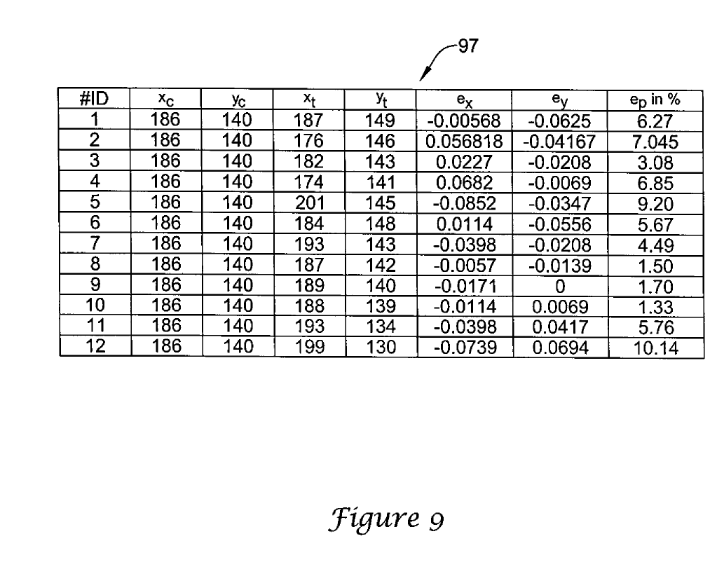

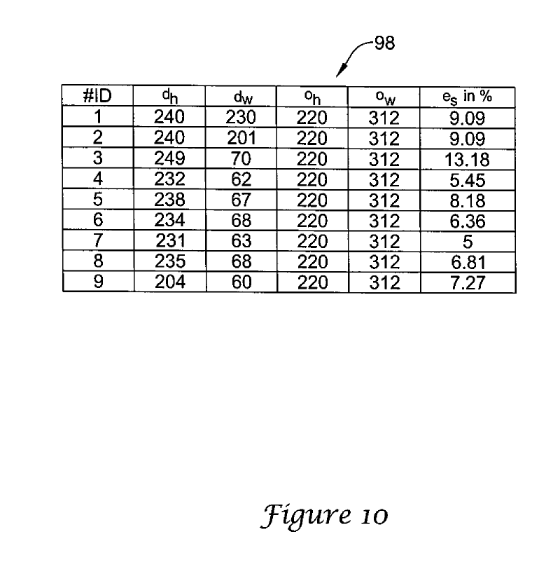

The target size may represent either the target's width or height depending upon its aspect ratio. The control algorithm may compute the zoom factor based on both target width and height. However, a minimum of the two zoom factors may be used to preserve the target aspect ratio. The scaling error may be computed using the target width or height based on which the zoom factor is applied. The position error may be computed for examples in a table 97 in FIG. 9, while the scaling error for the same examples may be computed in table 98 in FIG. 10. For latter examples of the table in FIG. 9, the zoom limit may be reached and thus calculation of scaling error should not be applicable for the table in FIG. 10.

Master-slave control may be tested with a significant separation between the master and slave cameras. Both cameras may be mounted at a height of about 10 ft (3.05 m) and the separation between the cameras may be 6 ft (1.83 m). All test data sets except one each (observation #12 of the table in FIG. 9 for location error and observation #3 of the table in FIG. 10 for zoom error) may achieve the targeted specification of ten percent positional accuracy and ten percent zoom accuracy. Location error may be found to be a minimum at the scene centre and to increase outwards from the centre in all directions. The eₓ—error distribution may be symmetrical about central horizontal line, while eₓ—error may be symmetrical about central vertical axis. Scale error eₛ may also increase as one moves away from the scene centre. The accuracy for both location and zoom may be significantly better while using a single PTZ camera under master-slave mode. This may indicate that the accuracy of master-slave control should significantly improve as the separation between master and slave cameras is decreased.

An algorithm hereto may be been developed to support event based autonomous PTZ camera control, such as automatic tracking of moving objects (e.g., people), and zooming in onto a face to get a closer look. One way to use this solution may be to operate the PTZ camera in tandem with a fixed camera. The solution may also be offered in conjunction with a single PTZ camera. In this mode, the fixed camera view may be substituted by a wide field of view mode. The PTZ camera may operate in a wide field of view mode under normal circumstances. Once a target is detected, the camera may zoom in to get a closer view of the target. The heart of the algorithm may be a semi-automatic calibration procedure that computes a PTZ camera optical centre, relative zoom, pan and tilt models with very simple user input. Two of the calibration steps, namely optical centre computation and zoom calibration, may be carried out as a part of a one time factory setting for the camera.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A target image acquisition system comprising:
a first camera; and
a second camera connected to the first camera; and
wherein:
the first camera is a fixed field-of-view camera;
the second camera is a variable field-of-view camera;
the first camera is for acquiring an image having a target sought in a fixed field of view;
the distance of the target from the first camera is determined by a size of the target; and
the physical size of the target has a nearly constant dimension.

2. The system of claim 1, wherein the first and second cameras operate in a master-slave relationship.

3. The system of claim 2, wherein:
the target is a face of a person; and
a size of the face is nearly a constant size for virtually all human persons.

4. The system of claim 2, wherein:
the target is a torso of a person; and
a size of the torso is an approximately constant size for nearly all persons.

5. The system of claim 2, wherein coordinates of pixels of the target are mapped from the first camera to the second camera.

6. The system of claim 5, wherein the first camera and the second camera are located within a certain distance from each other.

7. The system of claim 5, wherein the size of the target and coordinates of pixels of the target mapped to the second camera permit the second camera to pan, tilt and zoom in at a location of the target sought in a low resolution image of the first camera to capture a high resolution image of the target.

8. The system of claim 7, wherein the cameras comprise sensors for capturing images in color, black and white, near infrared or infrared.

9. The system of claim 7, wherein, due to incidental movement of one or both cameras, an update of a mapping of coordinates of an image from the first camera to the second camera is effected.

10. The system of claim 7, wherein, multiple fixed field of views of the master camera, will require multiple registration of the slave camera.

11. The system of claim 1, wherein:
the first and second cameras have operations contained in one camera structure;
the camera structure operates first as a fixed wide field of view camera; and
upon capturing and box bordering a target in a fixed wide field of view, the camera structure switches to a pan, tilt and zoom camera to capture a high resolution image of the target.

12. A method for capturing a high resolution image of a target comprising:
capturing a wide field of view low-resolution image incorporating a target;
determining a distance of the target according to a given size of the target;
determining a position of the target;
zooming in on the target along with pan and tilt adjustments; and
capturing a high resolution image of the target; and
wherein various targets of particular kind have a characteristic of a common size.

13. The method of claim 12, wherein the given size of the target is a common size of a human face or torso.

14. The method of claim 12, wherein the given size of the target is a common size of an automobile license plate.

15. The method of claim 12, wherein:
the wide field of view low-resolution image of the target is captured with a master camera;
the high resolution image of the target is captured with a slave camera; and
the cameras operate in a master-slave relationship.

16. The method of claim 15, wherein the coordinates of the low-resolution image in the master camera are mapped to the slave camera.

17. The method claim 12, further calculating the pan and tilt adjustments from the distance and the position of the target.

18. A system for capturing a high-resolution image of a target, comprising:
a first camera;
a second camera; and
a processor connected to the first and second cameras; and
wherein:
the first camera is for capturing a wide angle low resolution image of a target;
the target is a body part of a human being;
the body part has a certain size for virtually all human beings;
the processor is for mapping coordinates of pixels in the image of the target to the second camera;
the certain size is input to the processor;
a position of the target is determined by the processor from the image of the target captured by the first camera;
the distance of the target from the first camera is determined according to the certain size by the processor; and
pan, tilt and zoom adjustments are calculated by the processor from the position and distance of the target to enable the second camera to capture a high resolution image of the target.

19. The system of claim 18, wherein:
the body part is a face or torso of a human being; and
the body part is border-boxed as a target in the wide field of view image.

20. The system of claim 19, wherein:
the first and second cameras are situated laterally within a certain distance from each other;
the first and second cameras capture images in color, black and white, near infrared or infrared; and
due to incidental movement of one or both of the first and second cameras, an update of coordinates of the pixels of the image of the target to the second camera is effected by the processor.
